(19) United States
(12) Patent Application Publication
(10) Pub. No.: US 2006/0107214 A1
(43) Pub. Date: May 18, 2006

(54) Display apparatus and control method thereof

(76) Inventor: Young-chan Kim, Uiwang-si (KR)

Correspondence Address: STANZIONE & KIM, LLP, 919 18TH STREET, N.W., SUITE 440, WASHINGTON, DC, 20006, US

(21) Appl. No.: 11/272,146

(22) Filed: Nov. 14, 2005

(30) Foreign Application Priority Data
Nov. 15, 2004 (KR) 2004-93260

(51) Int. Cl. H04N 5/44

(52) U.S. Cl. 715/716

(57) ABSTRACT

The present invention relates to a display apparatus including a display part displaying an image based on a video signal, an on screen display generator generating an on screen display menu including a plurality of on screen display items for adjusting a display state of the display apparatus, a selection input part for selecting the on screen display item and an auto-adjustment operation, and a controller automatically adjusting the display state corresponding to the selected on screen display item when one of the plurality of OSD items is selected and the auto-adjustment function is selected.

### CROSS-REFERENCE TO RELATED APPLICATION

This application claims priority to and the benefit of Korean Patent Application No. 10-2004-0093260, filed on Nov. 15, 2004, in the Korean Intellectual Property Office, which is hereby incorporated by reference for all purposes as if fully set forth herein.

### BACKGROUND OF THE INVENTION

1. Field of the Invention

The present invention relates to a display apparatus and a control method thereof, and more particularly, to a display apparatus having an auto-adjustment function of an on-screen display (OSD) item, and a control method thereof.

2. Description of the Related Art

Most conventional display apparatus have an OSD menu that includes many items corresponding to functions to be adjusted for changing a display state thereof. In the OSD menu are provided a plurality of OSD items corresponding to functions to be adjusted.

Such display apparatus typically have OSD buttons to display an OSD menu thereon and adjust the various display states. Among the OSD buttons, an auto-adjustment button that automatically adjusts the OSD items may be provided for optimizing the display states by adjusting OSD items automatically. All auto-adjustable OSD items of the OSD menu are automatically adjusted when the auto-adjustment button is selected.

Thus, even when a user only wants to apply the OSD auto-adjustment function to a particular or selected OSD item, the OSD auto-adjustment function is applied to another of the auto-adjustable OSD items making it difficult to satisfy the user's demands.

### SUMMARY OF THE INVENTION

The present invention provides for a display apparatus and a control method thereof, in which an auto-adjustment function is applied to only OSD items selected by a user.

According to an embodiment of the invention, there is provided a display apparatus including a display part displaying an image based on a video signal, an on screen display generator generating an on screen display menu comprising a plurality of on screen display items for adjusting a display state of the display apparatus, a selection input part for selecting the on screen display item and an auto-adjustment operation, and a controller automatically adjusting the display state corresponding to the selected on screen display item when one of the plurality of OSD items is selected and the auto-adjustment function is selected.

According to another embodiment of the invention, there is provided a method of controlling a display apparatus including a display part to display an image based on a video signal, and an on screen display generator to generate an on screen display menu including a plurality of on screen display items for adjusting a display state of the display apparatus, the method including selecting the on screen display menu to be displayed, displaying the OSD menu comprising the plurality of on screen display items on the display part, allowing a selection of one of the plurality of on screen display items, and automatically adjusting the display state corresponding to the selected on screen display item when an auto-adjustment function is selected.

According to another embodiment of the invention, there is provided a method of controlling a display apparatus including an on screen display generator to generate an on screen display menu comprising a plurality of on screen display items for adjusting a display state of the display apparatus, and a selection input part to allow a user to select the on screen display items and an auto-adjustment function, the method includes determining whether the on screen display menu is activated, when the auto-adjustment function is selected through the selection input part; and automatically adjusting the display state corresponding to the selected on screen display item of the on screen display menu when the on screen display menu is activated.

Additional features of the invention will be set forth in the description which follows, and in part will be apparent from the description, or may be learned by practice of the invention.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1 is a control block diagram of a display apparatus according to a first embodiment of the invention.

FIG. 2 illustrates on screen display adjustment windows in the display apparatus according to the first embodiment of the invention.

FIG. 3 is a control flowchart of an on screen display auto-adjustment method in the display apparatus according to the first embodiment of the invention.

FIG. 4 illustrates on screen display adjustment windows in a display apparatus according to a second embodiment of the invention.

FIG. 5 is a control flowchart of an on screen display auto-adjustment method in the display apparatus according to the second embodiment of the invention.

### DESCRIPTION OF THE ILLUSTRATED EMBODIMENTS

Reference will now be made in detail to the embodiments of the present invention, examples of which are illustrated in the accompanying drawings, wherein like reference numerals refer to like elements throughout. The embodiments are described below in order to explain the present invention by referring to the figures.

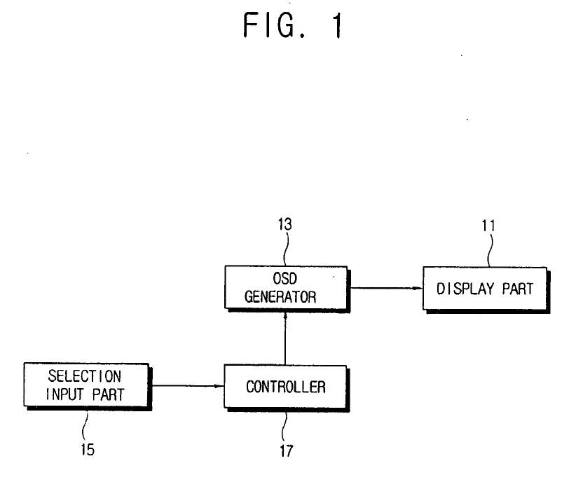

FIG. 1 is a control block diagram of a display apparatus according to a first embodiment of the invention. Referring to FIG. 1, there is provided a display apparatus having a display part 11 to display an image according to a video signal; an OSD generator 13 to generate an OSD menu having OSD items for adjusting a display state of the display apparatus; a selection input part 15 to select and adjust an OSD function; and a controller 17 to implement a function corresponding to at least one of the OSD items and an auto-adjustment function selected by a user through the selection input part 15.

The display part 11 displays the image according to the video signal. The display part 11 may be a flat panel display, such as a liquid crystal display (LCD), a plasma display panel (PDP), or the like.

The OSD generator 13 processes a signal to generate the OSD menu for adjusting the display state of the display apparatus and displays the OSD menu on the display part 11. The OSD generator 13 may be realized by a scaler chip or a separate OSD integrated chip (IC).

The OSD menu includes various OSD items for adjusting the display state of the display apparatus, for example, brightness, contrast, horizontal and vertical positions, size, etc.

The selection input part 15 is provided for selecting and/or adjusting the OSD items from the OSD menu, selecting the auto-adjustment function, and for implementing the adjustment of the display state. Here, the selection input part 15 may be realized by a button, a key, or the like, placed on the display apparatus. Alternatively, the selection input part 15 may be a button, a key, or the like, placed on a remote control device. The selection input part 15 may include a separate button, key, or the like, for selecting the auto-adjustment function.

The controller 17 controls the display apparatus to display the OSD menu and the OSD items on the display part 11 when the OSD menu and the OSD items are selected or adjusted by a user through the selection input part 15. The controller 17 may be realized by a microcomputer (MICOM).

Further, the controller 17 controls the display apparatus to automatically adjust the display state corresponding to an OSD item when a user selects the OSD item and the auto-adjustment function. Additionally, the controller 17 is described in more detail here below.

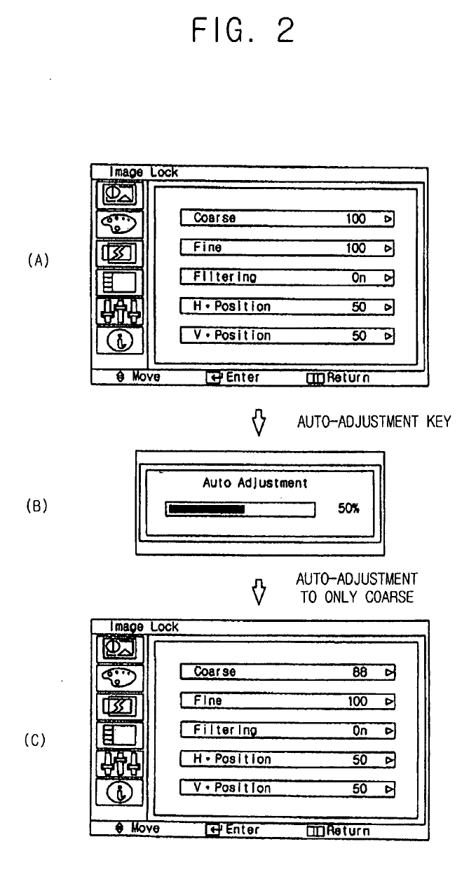

FIG. 2 illustrates OSD adjustment windows in the display apparatus according to, for example, the first embodiment of the invention. Referring to (A) of FIG. 2, in a non-limiting embodiment, the OSD menu is represented by six icons in a region of a display window, and the third icon from the top icon includes five OSD items shown in another region of the display window. The window may be obtained by selecting the OSD item through the selection input part 15 provided in the display apparatus.

Referring to (B) of FIG. 2, in a non-limiting embodiment, there is shown a display that occurs when a user selects the “Coarse” item among the displayed OSD items, e.g., “Coarse”, “Fine”, “Filtering”, “H-position”, and “V-position,” and also selects an auto-adjustment key. Specifically, the display shows a degree of progress of the implementation of the auto-adjustment function.

When the auto-adjustment function for the “Coarse” item is completed, e.g., degree of progress of the implementation of the auto-adjustment function is 100%, the adjusted “Coarse” item is displayed as shown in (C) of FIG. 2. The displayed image is not limited to the embodiment shown in (C) of FIG. 2. Thus, the OSD item, e.g., “Coarse,” selected by a user is automatically adjusted without adjusting the other OSD items.

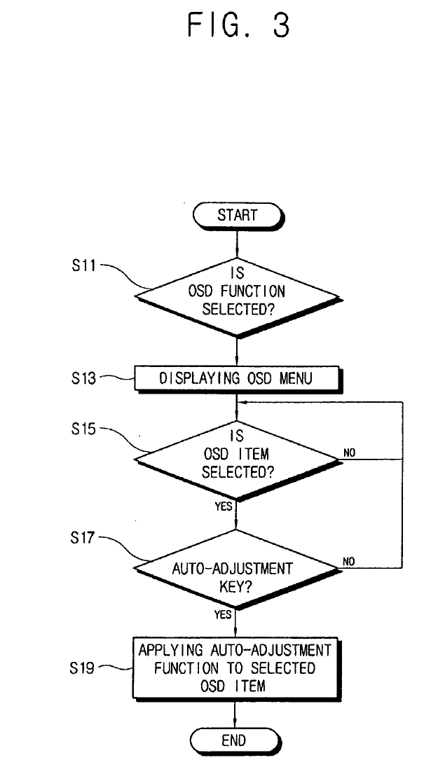

The OSD auto-adjustment method of the display apparatus according to the first embodiment of the invention is described below with reference to FIG. 3.

In a non-limiting embodiment of the invention, FIG. 3 is a control flowchart of the OSD auto-adjustment method. Referring to FIG. 3, in operation 11, a user selects an OSD function through the selection input part 15 provided in the display apparatus or the remote control device. In operation 13, the controller 17 controls the OSD generator 13 to display the OSD menu on the display part 11.

In operation 15, a user operates the selection input part 15 and selects one of the OSD items of the OSD menu displayed on the display part 11.

In operation 17, a user selects the auto-adjustment key provided on the selection input part 15.

In operation 19, the controller 17 controls the display apparatus to automatically adjust the display state thereof corresponding to the OSD item selected by the user.

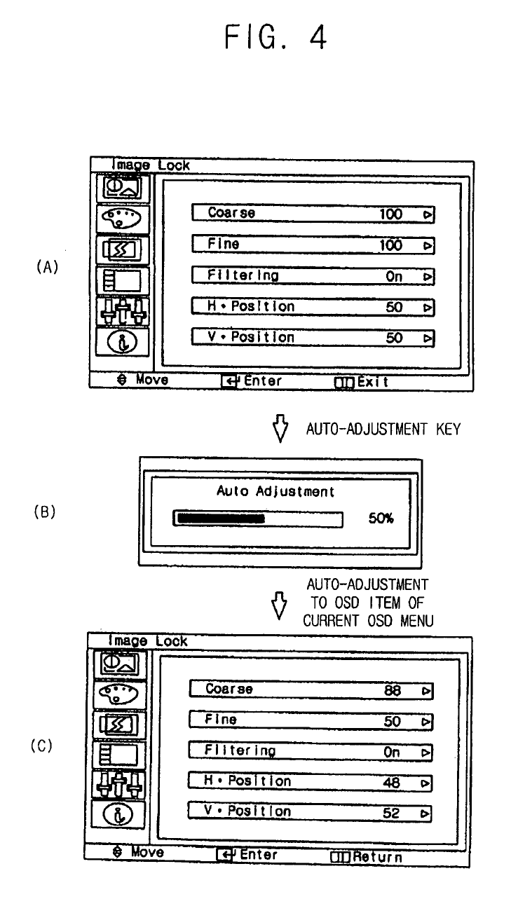

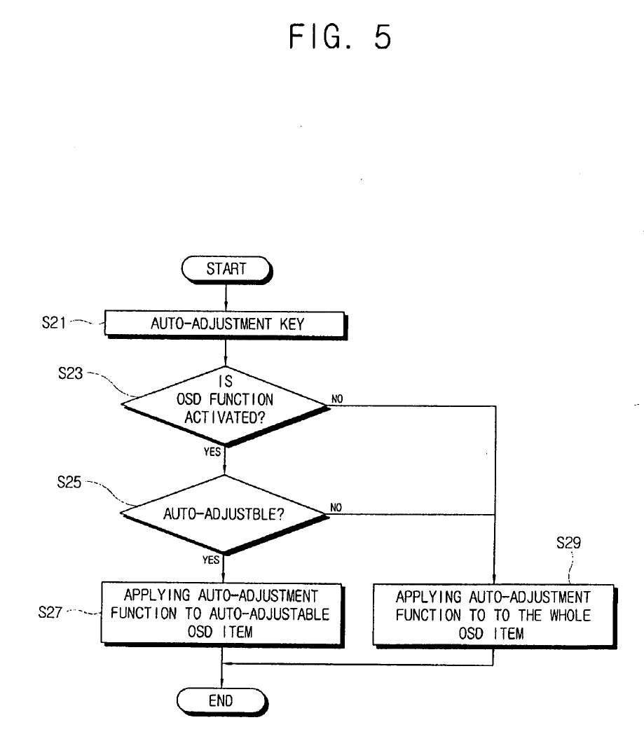

A display apparatus according to a second embodiment of the invention is described below with reference to FIGS. 4 and 5. In the description below, repetitive descriptions relating to the first embodiment will be avoided as necessary.

FIG. 4 illustrates OSD adjustment windows in a display apparatus. Referring to (A) of FIG. 4, in a non-limiting embodiment, the OSD menu is represented by six icons in a region of a display window, and the third icon from the top icon includes five OSD items shown in another region of the display window. When a specific OSD item is selected, the auto-adjustment function is implemented, which is similar to the first embodiment. However, when a specific OSD item is not selected, an auto-adjustment function is implemented as follows.

When the auto-adjustment key is selected without selecting the specific OSD item, the auto-adjustment function is implemented and the progress of implementation is displayed on the display apparatus, for example, as shown in (B) of FIG. 4.

When the auto-adjustment function is finished, all adjusted OSD items, e.g., adjusted “Coarse”, adjusted “Fine”, adjusted “Filtering”, adjusted “H-position”, and adjusted “V-position,” are displayed on the display apparatus, for example, as shown in (C) of FIG. 4. Further, all of the OSD items are automatically adjusted when the auto-adjustment key is selected and the OSD menu is not displayed on the display apparatus.

Further, when the selected OSD item includes a plurality of OSD sub-items, all the OSD sub-items are automatically adjusted.

Thus, when the user selects the auto-adjustment key without selecting the specific OSD item, all auto-adjustable OSD items of the OSD menu are automatically adjusted.

An OSD auto-adjustment method of the display apparatus according to the second embodiment of the invention is described below with reference to FIG. 5.

FIG. 5 is a control flowchart of an OSD auto-adjustment method in the display apparatus. Referring to FIG. 5, in a non-limiting embodiment, a user selects the auto-adjustment key in operation 21. In operation 23, the controller 17 determines whether the OSD function is activated, e.g., the controller 17 determines whether a user has selected one of the OSD items. Upon determining that the OSD function is activated, in operation 25, the controller 17 determines whether the corresponding OSD item is auto-adjustable.

When the selected OSD item is auto-adjustable, in operation 27, the controller 17 implements the auto-adjustment function for the corresponding OSD item.

However, when no OSD item is selected (not activated) or the selected OSD item is not auto-adjustable, then, in operation 29, all of the OSD items corresponding to the displayed OSD menu are automatically implemented.

Thus, when the OSD menu is not activated, the controller 17 applies the auto-adjustment function to all of the OSD items.

Therefore, the specific OSD item selected by a user, all the auto-adjustable OSD items corresponding to the specific OSD menu, or all of the OSD items may be automatically adjusted according to whether the OSD function is activated.

It is understood that in the above described embodiments of the invention, a user of the present invention may be any person, machine, or device that operates the display apparatus.

As described above, the present invention provides a display apparatus and a control method thereof, in which an auto-adjustment function is applied to only OSD items selected by a user.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A display apparatus, comprising:
a display part displaying an image based on a video signal;
an on screen display generator generating an on screen display menu comprising a plurality of on screen display items for adjusting a display state of the display apparatus;
a selection input part for selecting the on screen display item and an auto-adjustment operation; and
a controller automatically adjusting the display state corresponding to the selected on screen display item when one of the plurality of OSD items is selected and the auto-adjustment function is selected.

2. The display apparatus of claim 1, wherein the controller automatically adjusts the display state corresponding to all auto-adjustable on screen display items of the on screen display menu displayed on the display part when no on screen display item is selected.

3. The display apparatus of claim 1, wherein the controller automatically adjusts the display state corresponding to a plurality of on screen display sub-items when the selected on screen display item comprises the plurality of on screen display sub-items.

4. A method of controlling a display apparatus comprising a display part to display an image based on a video signal, and an on screen display generator to generate an on screen display menu comprising a plurality of on screen display items for adjusting a display state of the display apparatus, the method comprising:
selecting the on screen display menu to be displayed;
displaying the OSD menu comprising the plurality of on screen display items on the display part;
allowing a selection of one of the plurality of on screen display items; and
automatically adjusting the display state corresponding to the selected on screen display item when an auto-adjustment function is selected.

5. The method of claim 4, further comprising:
automatically adjusting the display state corresponding to all auto-adjustable on screen display items of the on screen display menu displayed on the display part when no on screen display item is selected.

6. The method of claim 4, further comprising:
automatically adjusting the display state corresponding to a plurality of on screen display sub-items when the on screen display item selected by a user comprises the plurality of OSD sub-items.

7. A method of controlling a display apparatus comprising an on screen display generator to generate an on screen display menu comprising a plurality of on screen display items for adjusting a display state of the display apparatus, and a selection input part to allow a user to select the on screen display items and an auto-adjustment function, the method comprising:
determining whether the on screen display menu is activated, when the auto-adjustment function is selected through the selection input part; and
automatically adjusting the display state corresponding to the selected on screen display item of the on screen display menu when the on screen display menu is activated.

8. The method according to claim 7, further comprising:
automatically adjusting the display state corresponding to all auto-adjustable on screen display items of the on screen display menu when no on screen display menu is activated.

9. The method according to claim 7, further comprising:
automatically adjusting the display state corresponding to a plurality of on screen display sub-items when the on screen display item selected by a user comprises the plurality of on screen display sub-items.
